(19) United States
(12) Patent Application Publication
(10) Pub. No.: US 2026/0332904 A1
(43) Pub. Date: Oct. 22, 2026

(54) IMAGE CAPTURING DEVICE TUNING METHOD, TUNING DEVICE AND IMAGE CAPTURING DEVICE

(71) Applicant: MEDIATEK INC., Hsinchu City (TW)

(72) Inventor: Chi-De Chen, Hsinchu City (TW)

(73) Assignee: MEDIATEK INC., Hsinchu City (TW)

(21) Appl. No.: 19/185,230

(22) Filed: Apr. 21, 2025

(51) Int. Cl. H04N 23/81

(52) U.S. Cl. CPC H04N 23/81

(57) ABSTRACT

An image capturing device tuning method, comprising: (a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels; (b) computing second noise levels of second images generated by a second image capturing device, wherein the second images correspond to a second set of ISO values associated with the second noise levels; (c) computing a second set of operating parameters with second operating parameters for the second noise levels of the second image capturing device according to the first set of operating parameters.

### BACKGROUND

The present application relates to an image capturing device tuning method, a tuning device and an image capturing device, and particularly relates to an image capturing device tuning method, a tuning device and an image capturing device which can set an image capturing device according to operating parameters provided by a professional staff.

A camera always comprises various devices such as a lens, an image sensor and an ISP. The operating parameters of these devices need to be tuned or the images generated of the camera could not be optimized, and the camera may even not operate properly. However, the operating parameters of these components are complicated and hard to be set properly. A well trained staff may provide proper operating parameters. However, such professional staff is hard to be trained, but the generation of new types of cameras is very quick. Accordingly, the number of professional staff is not enough to provide proper operating parameters for various types of cameras.

### SUMMARY

One objective of the present application is to provide an image capturing device tuning method which can decrease a required number of professional staffs.

Another objective of the present application is to provide a tuning device which can decrease a required number of professional staffs.

Still another objective of the present application is to provide an image capturing device which can decrease a required number of professional staffs.

One embodiment of the present application discloses an image capturing device tuning method, comprising: (a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels; (b) computing second noise levels of second images generated by a second image capturing device, wherein the second images correspond to a second set of ISO values associated with the second noise levels; (c) computing a second set of operating parameters with second operating parameters for the second noise levels of the second image capturing device according to the first set of operating parameters.

Another embodiment of the present application discloses a tuning device, comprising: a storage device, configured to store at least one program; a processing circuit, configured to perform an image capturing device tuning method comprising: (a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels; (b) computing second noise levels of second images generated by a second image capturing device, wherein the second images correspond to a second set of ISO values associated with the second noise levels; (c) computing a second set of operating parameters with second operating parameters for the second noise levels of the second image capturing device according to the first set of operating parameters.

Still another embodiment of the present application discloses an image recording device, comprising: a storage device, configured to store at least one program; and a processing circuit, configured to perform an image capturing device tuning method comprising: (a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels; (b) computing second noise levels of second images generated by the image capturing device, wherein the second images correspond to a second set of ISO values associated with the second noise levels; and (c) computing a second set of operating parameters with second operating parameters for the second noise levels of the image capturing device according to the first set of operating parameters.

In view of above-mentioned embodiments, the number of professional staffs which are needed to set numerous types of cameras can be decreased. By this way, the cost of manufacturer may be decreased and the development of new types of cameras may be speed up.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image capturing device which is used in the present application, according to one embodiment of the present application.

FIG. 2 is a schematic diagram illustrating the image capturing device tuning method, according to one embodiment of the present application.

FIGS. 3 and 4 are line charts illustrating an image capturing device tuning methods, according to embodiments of the present application.

FIG. 5 is a schematic diagram illustrating an image capturing device tuning method using the rules illustrated in FIGS. 3 and 4, according to one embodiment of the present invention.

FIG. 6 is a flow chart illustrating an image capturing device tuning method, according to one embodiment of the present application.

FIG. 7 is a block diagram illustrating a tuning device according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

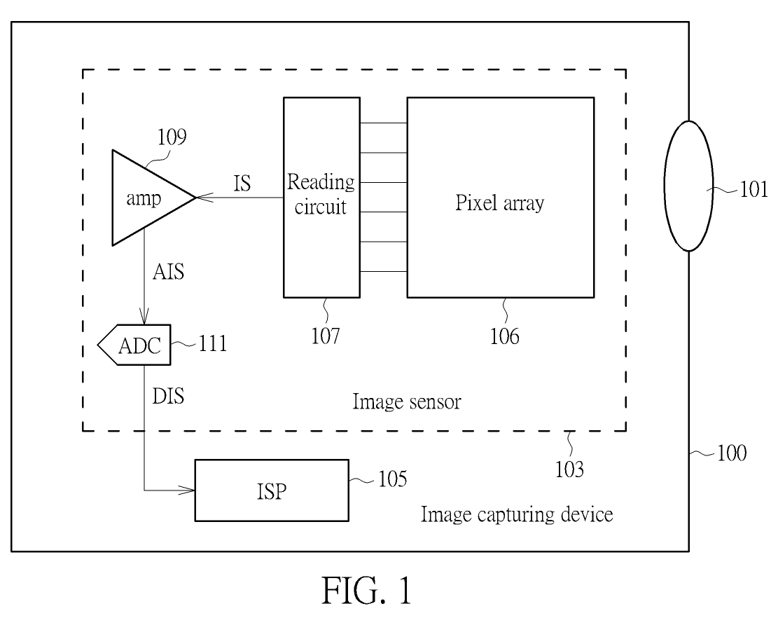

FIG. 1 is a block diagram illustrating an image capturing device 100 which is used in the present application, according to one embodiment of the present application. It will be appreciated that the following embodiments are not limited to be implemented by the image capturing device 100 in FIG. 1. In one embodiment, the image capturing device 100 is a camera, and may be an independent electronic device or be integrated to another electronic device such as a mobile phone or a tablet computer.

As shown in FIG. 1, the image capturing device 100 comprises a lens 101, an image sensor 103 and an ISP (image signal processor) 105. The image sensor 103 in FIG. 1 comprises a pixel array 106, a reading circuit 107, an image signal amplifying circuit 109, and an ADC 111. The pixel array 106 comprises a plurality of pixels which generate sensing charges corresponding to the received light passing through the lens 101.

The image signal amplifying circuit 109 is configured to amplify the image signal IS to generate an amplified image signal AIS. The amplified image signal AIS is transmitted to an ADC 111 to generate a digital image signal DIS (the pixel values of the sensing image SI). The digital image signal DIS is transmitted to an ISP 105, which may generate images according to the digital image signals. The ISP 105 may be integrated to the image sensor 103 or independent from the image sensor 103.

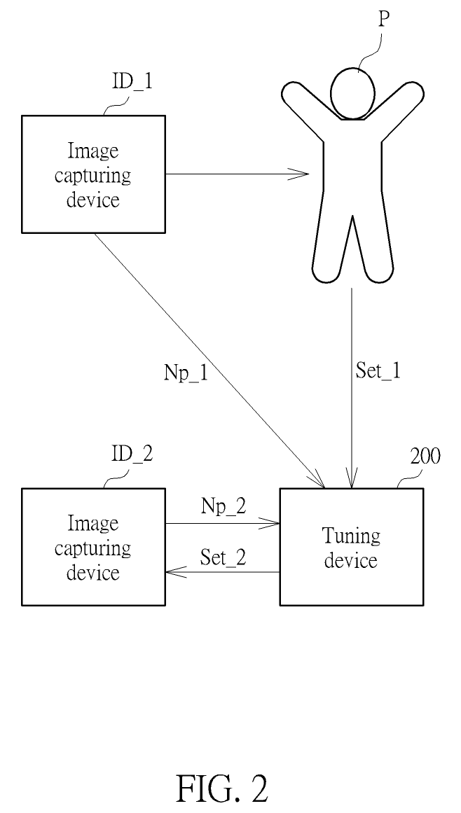

FIG. 2 is a schematic diagram illustrating the image capturing device tuning method, according to one embodiment of the present application. In the embodiment of FIG. 2, a professional staff P may adjust the first image capturing device ID_1 to use a first set of operating parameters Set_1. The first set of operating parameters Set_1 may comprise a plurality of first operating parameters. By using the first set of operating parameters Set_1, the first image capturing device ID_1 may generate more ideal images, which may have low noise levels, but not limited. Then, a first noise profile Np_1 is acquired by capturing images using the first set of operating parameters Set_1. The first noise profile Np_1 comprises noise information (e.g., noise levels) of first images generated by the first image capturing device ID_1. Specifically, the first noise profile Np_1 is generated when at least one first device of the first image capturing device ID_1 uses the first set of operating parameters to capture first images.

Also, the second noise profile Np_2 comprises noise information of second images generated by the second image capturing device ID_2 is acquired. Specifically, the second noise profile Np_2 is generated when at least one second device of the second image capturing device ID_2 uses a second set of operating parameters to capture second images. The second set of operating parameters may comprise a plurality of second operating parameters.

After acquiring the first noise profile Np_1, the second noise profile Np_2 and the first set of operating parameters Set_1, the tuning device 200 may automatically adjust the second set of operating parameters Set_2 according to the first noise profile Np_1, the second noise profile Np_2 and the first set of operating parameters Set_1.

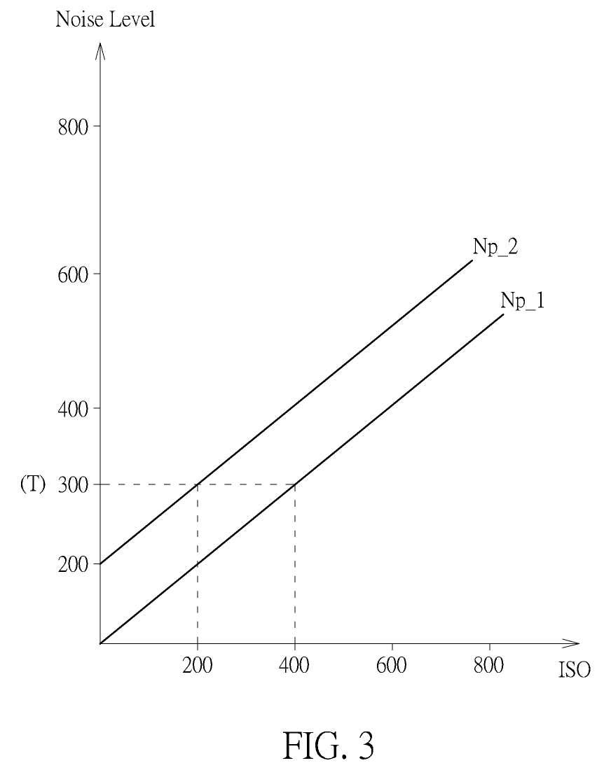

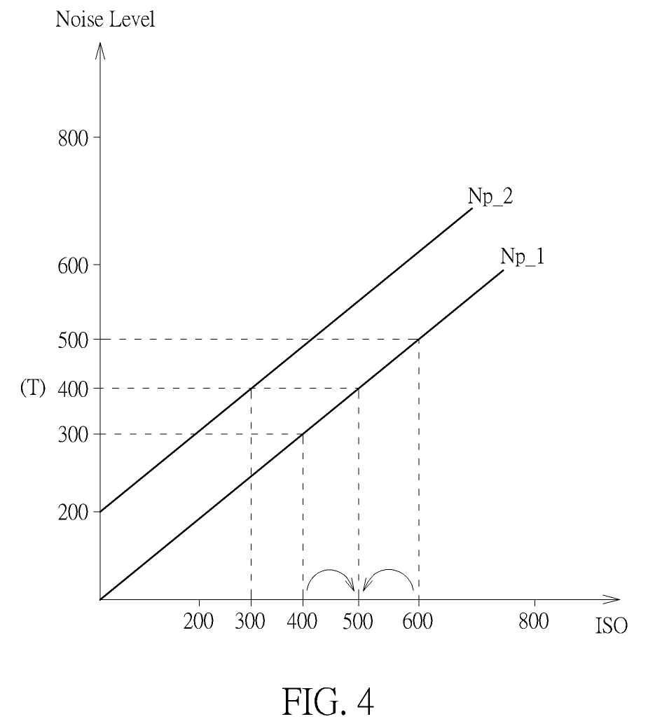

FIGS. 3 and 4, which are detail examples of the embodiment illustrated in FIG. 2, are line charts illustrating an image capturing device tuning method, according to embodiments of the present application. The above-mentioned first device and second device may be a lens, an image sensor or an ISP. In the embodiments of FIGS. 3 and 4, the first device and the second device are respectively image sensors of the first imager recording device ID_1 and the second imager recording device ID_2. In the embodiment of FIG. 3, the second operating parameters of the image sensor (herein after, image sensor 2) of the second image capturing device ID_2 is to be computed. More specifically, in the embodiment of FIG. 3, the second operation parameters of the image sensor 2 when the second image capturing device ID_2 has an ISO value 200 is to be computed.

The noise level, which corresponds to the ISO value 200, of the images generated by the image sensor 2 is firstly acquired. The noise level is 300 in the embodiment of FIG. 3. Then, the ISO value of the first image capturing device ID_1, which corresponds to the noise level 300, is acquired. In the embodiment of FIG. 3, the ISO value of the first image capturing device ID_1, which corresponds to the noise level 300, is 400. After that, at least portion of the first operating parameters, which corresponds to the ISO value 400, is set to the image sensor 2.

The second operating parameters of the image sensor 2 is not limited to be computed via the embodiment illustrated in FIG. 3. In the embodiment of FIG. 3, the ISO value corresponding to the target noise level is known. More specifically, in FIG. 3, the ISO value corresponding to the target noise level 300 is 400. However, in some cases, the ISO value corresponding to the target noise level is not known (not acquired). In such case, the ISO value corresponding to the target noise level may be acquired by interpolation.

As shown in FIG. 4, the target noise level corresponding to the ISO value 300 is acquired, which is 400 in the embodiment of FIG. 4. However, the ISO value of the first image capturing device ID_1, which causes the noise level 400 is not known. Accordingly, in the embodiment of FIG. 4, the ISO value of the first capturing device ID_1 corresponding to the noise level 500 and the ISO value of the first capturing device ID_1 corresponding to the noise level 300 are acquired. After that, the ISO value of the first capturing device ID_1 corresponding to the noise level 400, which is 500, is acquired via interpolating the ISO values 400 and 600. Accordingly, at least portion of the first operating parameters, which corresponds to the ISO value 500, is set to the image sensor 2. The operating parameters corresponding to other ISO values may be set following the above-mentioned embodiments in FIGS. 3 and 4. However, curves of the noise profile are not limited to the straight lines illustrated in FIGS. 3 and 4.

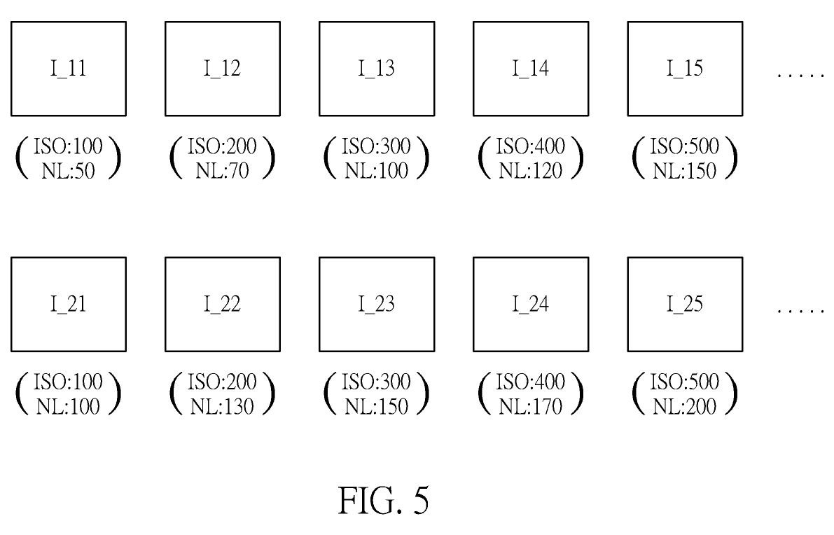

The rules stated in FIGS. 3 and 4 can be used in various operations of the first image capturing device ID_1 and the second image capturing device ID_2. FIG. 5 is a schematic diagram illustrating an image capturing device tuning method using the rules illustrated in FIGS. 3 and 4, according to one embodiment of the present invention. In the embodiment of FIG. 5, the first image capturing device ID_1 uses a first set of operating parameters and different ISO values to generate a plurality of first images (only five first images I_11…I_15 are used as examples for explaining).The first set of operating parameters may comprise first operating parameters for different ISO values.

Similarly, the second image capturing device ID_2 uses a second set of operating parameters and different ISO values to generate a plurality of second images(only five first images I_21…I_25 are used as examples for explaining). The second set of operating parameters may comprise second operating parameters for different ISO values. Also, first noise levels of the first images I_11…I_15 and the second noise levels of the second images I_21…I_25 are computed. After that, new second operating parameters for the second operating parameters are computed (i.e., the second operating parameters are updated) according to the first set of operating parameters, based on the embodiment illustrated in FIGS. 3 and 4.

For example, in the embodiment of FIG. 5, the second image I_21 is generated with an ISO value 100, and has a noise level 100. Also, in the embodiment of FIG. 5, the first image I_13 is generated with an ISO value 300, and has a noise level 100. In such case, the ISO value of the first image capturing device ID_1, which corresponds to the target noise level 100, is known (or acquired). Accordingly, based on the embodiment of FIG. 3, the first operating parameters of the first image capturing device ID_1 while using the ISO value 300 can be used as the second operating parameters of the second image capturing device ID_2 while using the ISO value 100, since the second image I_21 and the first image I_13 both have the same noise level 100.

Further, in the embodiment of FIG. 5, the second image I_22 is generated with an ISO value 200, and has a noise level 130. However, no first image in FIG. 5 has a noise level 130. In such case, the ISO value of the first image capturing device ID_1, which corresponds to the target noise level 130, is not known (or not acquired). Accordingly, based on the embodiment of FIG. 4, the second operating parameters, which corresponds to the ISO value 200 and are used for generating the second image I_22, can be acquired by interpolating the first operating parameters which corresponds to the ISO value 400 and are used for generating the second image I_14 that has the noise level 120, and the first operating parameters which corresponds to the ISO value 500 and are used for generating the second image I_15 which has the noise level 150. That is, the second operating parameters of second image capturing device ID_2 while using the ISO value 200 can be computed by interpolating the first operating parameters of first image capturing device ID_1 while using the ISO value 400 and the first operating parameters of first image capturing device ID_1 while using the ISO value 500.

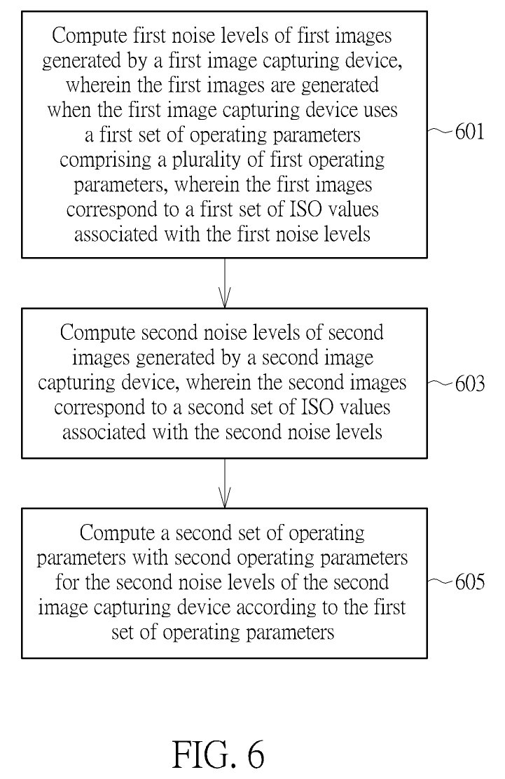

In view of above-mentioned embodiments, an image capturing device tuning method may be acquired. FIG. 6 is a flow chart illustrating an image capturing device tuning method, according to one embodiment of the present application. The image capturing device tuning method, which corresponds to the embodiment of FIG. 5, may be applied to at least one device of an image capturing device. The device may be a lens, an image sensor or an ISP. The image capturing device tuning method comprises:

### Step 601

Compute first noise levels of first images (e.g., first images I_11, I_12…I_15 in FIG. 5) generated by a first image capturing device, wherein the first images are generated when the first image capturing device uses a first set of operating parameters comprising a plurality of first operating parameters, wherein the first images correspond to a first set of ISO values associated with the first noise levels.

### STEP 603

Compute second noise levels of second images (e.g., second images I_21, I_22…I_25 in FIG. 5)generated by a second image capturing device, wherein the second images correspond to a second set of ISO values associated with the second noise levels.

### STEP 605

Compute a second set of operating parameters with second operating parameters for the second noise levels of the second image capturing device according to the first set of operating parameters.

Corresponding to the embodiment of FIG. 3, the step 605 computes the second set of operating parameters with second operating parameters for the second noise levels according to the first set of operating parameters which cause identical ones of the first noise levels.

Corresponding to the embodiment of FIG. 4, the second operating parameters are computed by interpolating the first operating parameters with corresponding noise levels.

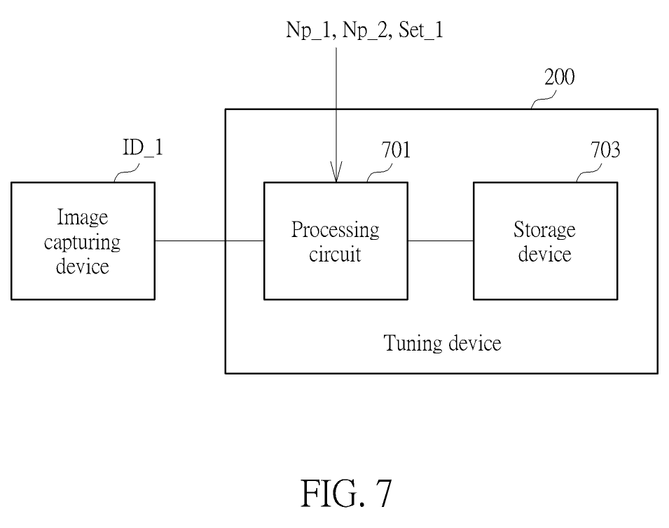

The above-mentioned methods may be performed by a tuning device. FIG. 7 is a block diagram illustrating a tuning device according to one embodiment of the present application. As shown in FIG. 6, the tuning device 200 comprises a processing circuit 701 and a storage device 703. The storage device 703 stores at least one program and the processing circuit 701 executes the program to perform the above-mentioned methods. As above-mentioned, the processing circuit 701 acquires the first noise profile Np_1, the second noise profile Np_2 and the first set of operating parameters Set_1 to adjust second operating parameters of at least one second device in the second image capturing device ID_2. Besides, the storage device 703 may be located outside the tuning device 200, rather than limited to be inside the tuning device 200.

Additionally, the tuning device 200 may be incorporated into the second image capturing device ID_2. In such case, the storage device 703 may be used to store images generated by the ISP 105 in FIG. 1. Besides, the ISP 105 may be independent from the processing circuit 701 or be incorporated into the processing circuit 701. In such case, the image capturing device may update new noise profiles from a network, and accordingly calibrate devices thereof.

The above-mentioned embodiments may be used to calibrate a plurality of devices of different image capturing devices. For example, the above-mentioned first set of operating parameters Set_1 may be applied to calibrate image sensors of the second image capturing device ID_2, a third image capturing device, and a fourth image capturing device rather than limited to the image sensor of the second image capturing device ID_2. In such case, the devices which are calibrated may have similar operating parameters since they are calibrated based on the same operating parameters. Moreover, if the devices which are calibrated are image sensors, the device may generate images with similar performance since they are calibrated based on the same operating parameters.

In view of above-mentioned embodiments, the number of professional staffs which are needed to set numerous types of cameras can be decreased. By this way, the cost of manufacturer may be decreased and the development of new types of cameras may be speed up.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image capturing device tuning method, comprising:
(a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels;
(b) computing second noise levels of second images generated by a second image capturing device, wherein the second images correspond to a second set of ISO values associated with the second noise levels; and
(c) computing a second set of operating parameters with second operating parameters for the second noise levels of the second image capturing device according to the first set of operating parameters.

2. The image capturing device tuning method of claim 1, wherein the second operating parameters are computed by interpolating the first operating parameters with corresponding noise levels.

3. The image capturing device tuning method of claim 1, wherein the first operating parameters and the second parameters are parameters of a lens, an image sensor or an ISP(image signal processor).

4. The image capturing device tuning method of claim 1, wherein the step(a) computes the first noise levels to generate a first noise profile of the first image capturing device.

5. The image capturing device tuning method of claim 1, wherein the step(a) computes the second noise levels to generate a second noise profile of the second image capturing device.

6. The image capturing device tuning method of claim 1, wherein the step (c) computes the second set of operating parameters with second operating parameters for the second noise levels according to the first set of operating parameters which cause identical ones of the first noise levels.

7. A tuning device, comprising:
a storage device, configured to store at least one program;
a processing circuit, configured to perform an image capturing device tuning method comprising:
(a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels;
(b) computing second noise levels of second images generated by a second image capturing device, wherein the second images correspond to a second set of ISO values associated with the second noise levels;
(c) computing a second set of operating parameters with second operating parameters for the second noise levels of the second image capturing device according to the first set of operating parameters.

8. The tuning device of claim 7, wherein the second operating parameters are computed by interpolating the first operating parameters with corresponding noise levels.

9. The tuning device of claim 7, wherein the first operating parameters and the second parameters are parameters of a lens, an image sensor or an ISP(image signal processor).

10. The tuning device of claim 7, wherein the step(a) computes the first noise levels to generate a first noise profile of the first image capturing device.

11. The tuning device of claim 7, wherein the step(a) computes the second noise levels to generate a second noise profile of the second image capturing device.

12. The tuning device of claim 7, wherein the step (c) computes the second set of operating parameters with second operating parameters for the second noise levels according to the first set of operating parameters which cause identical ones of the first noise levels.

13. An image recording device, comprising:
a storage device, configured to store at least one program; and
a processing circuit, configured to perform an image capturing device tuning method comprising:
(a) computing first noise levels of first images generated by a first image capturing device, wherein the first images are generated when the first image capturing device uses a first set of operating parameters comprising a plurality of first operating parameters, wherein the first images correspond to a first set of ISO values associated with the first noise levels;
(b) computing second noise levels of second images generated by the image capturing device, wherein the second images correspond to a second set of ISO values associated with the second noise levels; and
(c) computing a second set of operating parameters with second operating parameters for the second noise levels of the image capturing device according to the first set of operating parameters.

14. The image recording device of claim 13, wherein the second operating parameters are computed by interpolating the first operating parameters with corresponding noise levels.

15. The image recording device of claim 13, wherein the first operating parameters and the second parameters are parameters of a lens, an image sensor or an ISP(image signal processor).

16. The image recording device of claim 13, wherein the step(a) computes the first noise levels to generate a first noise profile of the first image capturing device.

17. The image recording device of claim 13, wherein the step(a) computes the second noise levels to generate a second noise profile of the second image capturing device.

18. The image recording device of claim 13, wherein the step (c) computes the second set of operating parameters with second operating parameters for the second noise levels according to the first set of operating parameters which cause identical ones of the first noise levels.
